(19) United States
(12) Patent Application Publication
(10) Pub. No.: US 2014/0180727 A1
(43) Pub. Date: Jun. 26, 2014

(54) System and Method for Classifying and Identifying a Driver Using Driving Performance Data

(71) Applicant: Insurance Services Office, Inc., Jersey City, NJ (US)

(72) Inventors: Avner Freiberger, Kfar-Saba (IL); David Izhaky, Tel-Aviv (IL); Ariel Shamir, Jerusalem (IL); Oren Steinberg, Tel-Aviv (IL); Asaf Tamir, Tel-Aviv (IL)

(73) Assignee: Insurance Services Office, Inc., Jersey City, NJ (US)

(21) Appl. No.: 14/049,837

(22) Filed: Oct. 9, 2013

Related U.S. Application Data
(60) Provisional application No. 61/711,224, filed on Oct. 9, 2012.

(51) Int. Cl. G06Q 40/08

(52) U.S. Cl. CPC G06Q 40/08
USPC 705/4

(57) ABSTRACT

Provided is a system and method for classifying and identifying a driver using driving performance data. The system comprises one or more devices in electronic communication with a network, the one or more devices including one or more sensors for obtaining driving performance data associated with operation of a vehicle by a driver, and a driving signature engine in electronic communication with the one or more devices, the driving signature engine designating at least one data channel for obtaining driving performance data, processing the driving performance data obtained from the data channel to determine code words, determining a driving signature according to the code words, and identifying or classifying the driver according to the determined driving signature.

### CROSS-REFERENCE TO RELATED APPLICATIONS

This application claims the benefit of U.S. Provisional Application Ser. No. 61/711,224 filed on Oct. 9, 2012, the entire disclosure of which is expressly incorporated herein by reference.

### BACKGROUND OF THE INVENTION

1. Field of the Invention

The present invention relates generally to systems for gathering and analyzing information related to a vehicle driving performance data, and more particularly, to a system and method for classifying and identifying a driver using driving performance data.

2. Background of the Invention

With the proliferation of connectivity, electronic systems, and personal devices in vehicles, it has become increasingly more feasible and economical to collect data from vehicles. A major benefit of such data is the ability to measure the performance of a driver and a vehicle, in both qualitative and quantitative aspects. This can be used in a variety of fields and by a variety of users (e.g., by drivers to improve their safety or fuel efficiencies, by vehicle owners to monitor their family's or fleet's safety or fuel efficiencies, by insurance companies to screen, rate, and price customers or to offer them new insurance programs, etc.).

Insurance companies have recently started using data from vehicle and driving monitoring devices to examine how people drive. In recent years, a few companies have been offering usage based auto insurance (UBI) programs to consumers, where the price of the insurance policy is linked to data coming from the vehicle. Usage based auto insurance is considered an important step in making insurance more affordable, fair, and transparent to consumers. Most programs use mileage or duration of trips to discount insurance rates for low-mileage drivers. Other programs use speed and acceleration measurements and count the number of risky driving events (e.g., speeding, braking) to discount safe drivers. Counting the number of such events may fail to provide data that can be used to differentiate between drivers because of the low frequency and limited detection accuracy of such discrete events, as well as the difficulties in using them to predict actual risk. The low number of discrete events used in prior art methods, and the irregular occurrence of such events in time, make it challenging to determine the behavior of drivers in a given period of time, and with higher vulnerability to “noise.” The use of a vehicle by multiple drivers (e.g., family cars, fleet vehicles, etc.) introduces additional challenges in determining the behavior of each driver.

### SUMMARY

A system and method for classifying and identifying a driver using driving performance data is provided. The system comprises one or more devices in electronic communication with a network, the one or more devices including one or more sensors for obtaining driving performance data associated with operation of a vehicle by a driver, and a driving signature engine in electronic communication with the one or more devices, the driving signature engine designating at least one data channel for obtaining driving performance data, processing the driving performance data obtained from the data channel to determine code words, determining a driving signature according to the code words, and identifying or classifying the driver according to the determined driving signature.

### BRIEF DESCRIPTION OF THE DRAWINGS

The disclosed subject matter will be described with reference to the following description in conjunction with the figures. The figures are generally not shown to scale and any sizes or actual positions are not necessarily limiting.

FIG. 1 is a diagram showing a system and method for classifying and identifying a driver using driving performance data;

FIG. 2 shows a driving signature processor of the system, for obtaining data samples and determining a driving signature;

FIG. 3 shows processing steps for determining a driving signature; and

FIG. 4 is a diagram showing hardware and software components of the system capable of performing the processes discussed herein.

### DETAILED DESCRIPTION

The present disclosure provides a system and method for classifying and identifying a driver using driving performance data. The system provides an accurate and predictive way to measure and analyze driving behavior. Classification and identification of a driver (e.g., a driving signature which could represent driving patterns in a continuous manner) could be used for insurance purposes and/or driving risk evaluation. The system could also be used to analyze, classify, and/or provide feedback and coaching to drivers and vehicle owners (e.g., for green driving (e.g., fuel efficient or environmentally friendly), personal safety, family safety, fleet safety, etc.).

The driving signature generated by the system is a succinct representation of collected data samples and is also descriptive of the driver's behavior and/or style of driving. The system determines the driving signature by collecting and analyzing driving data samples using sensors while the driver is driving the vehicle. The system and method granularly examine the frequent behavioral aspects of the driving style and/or driving signature (e.g., rather than discrete events which could happen occasionally or infrequently while driving) to accurately classify the driver and his/her driving behavior. The granularity could be achieved by relating and analyzing all available driving performance data (not just specific/sporadic driving events). In this way, the system uses continuous data without pre-selection of events, leading to the ability to classify a driver even when his/her driving at a given period of time does not include any harsh driving events.

The system collects driving performance data and extracts data patterns (e.g., repetitive code words) from the driving performance data. The system could then use and associate the code words (e.g., data patterns, predefined identifiable patterns, etc.) with a characterization (e.g., risk, safety, fuel consumption, etc.) of the driver according to a statistical model. In other words, the system does not determine in advance what constitutes a risky event, but collects all the patterns (e.g., code words) that can be found in the driving performance data and only then correlates the signature with risk and/or any other target function.

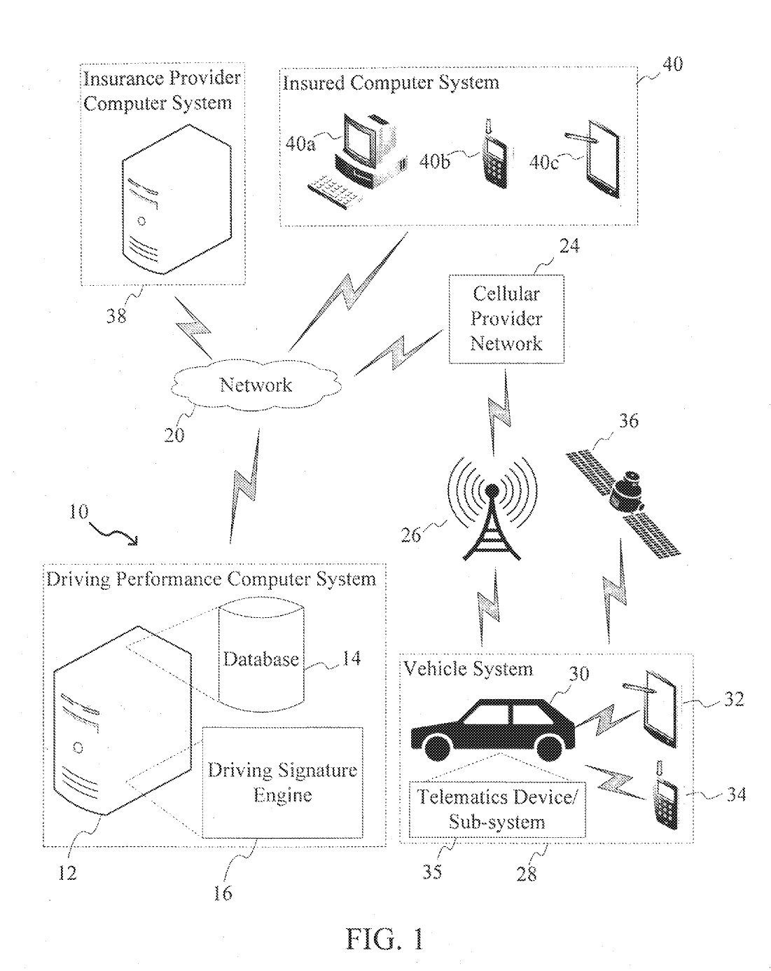

FIG. 1 is a diagram showing a system and method for classifying and identifying a driver using driving performance data, in accordance with the present disclosure. The system, indicated generally at 10, comprises a computer system 12 (e.g., a server) having a database 14 stored therein and a driving signature engine 16 executed by the computer system 12. The computer system 12 could be any suitable computer server (e.g., a server with a microprocessor, multiple processors, multiple processing cores) running any suitable operating system (e.g., Windows by Microsoft, Linux, UNIX, etc.). The database 14 could be stored on the computer system 12, or located externally therefrom (e.g., in a separate database server in communication with the system 10). As will be discussed in greater detail below, the engine 16, when executed by the computer system 12, provides the functionality described herein.

The system 10 communicates through a network 20 with one or more of a variety of computer systems. Network communication could be over the Internet using standard TCP/IP and/or UDP communications protocols (e.g., hypertext transfer protocol (HTTP), secure HTTP (HTTPS), file transfer protocol (FTP), electronic data interchange (EDI), dedicated protocol, etc.), through a private network connection (e.g., wide-area network (WAN) connection, emails, electronic data interchange (EDI) messages, extensible markup language (XML) messages, file transfer protocol (FTP) file transfers, etc.), or using any other suitable wired or wireless electronic communications format.

More specifically, the system 10 communicates with one or more vehicle systems 28 through a network 20, a cellular provider network 24, and one or more wireless networks or cellular antenna towers 26. The vehicle system 28 includes a vehicle 30 and one or more devices in the car and/or portable mobile devices (e.g., portable tablet computer 32, portable smartphone 34, telematics device 35, and/or telematics sub-system 35 of the vehicle). “Portable mobile device” means that that the device is configured to be easily taken into and out of a vehicle (e.g., not a permanent fixture in the vehicle). Additionally, an onboard diagnostics (OBD) system of the vehicle 30 and/or a telematics device 35 could communicate with the one or more mobile devices 32, 34, 35 as a complement or supplement to the mobile device or as the main source for data collection (e.g., to identify the vehicle using vehicle identification number (VIN) validated through the OBD port). The vehicle 30 itself and/or the mobile devices 32, 34, 35 could also communicate with a satellite system 36, such as for obtaining global positioning system (GPS) information. Information from the vehicle system 28 is transmitted periodically or continuously to the driving performance computer system 10 and/or stored in the database 14. However, at least some, if not all, of the functionality of the system 10 could be performed locally on mobile devices 32, 34, 35 (e.g., personal computer, smart cellular telephone (Apple iPhone), tablet computer, etc.) programmed with software (e.g., a software application or “app”) in accordance with the present disclosure.

Further, the driving performance computer system 10 could electronically communicate with one or more insurance provider computer systems 38 and one or more insured computer systems 40 (e.g., personal computer system 40a, a smart cellular telephone 40b, a tablet computer 40c, or other devices). Additionally, or alternative, an aggregator (e.g., online referrals agent), an insurance broker, etc. could also use and be in communication with the system.

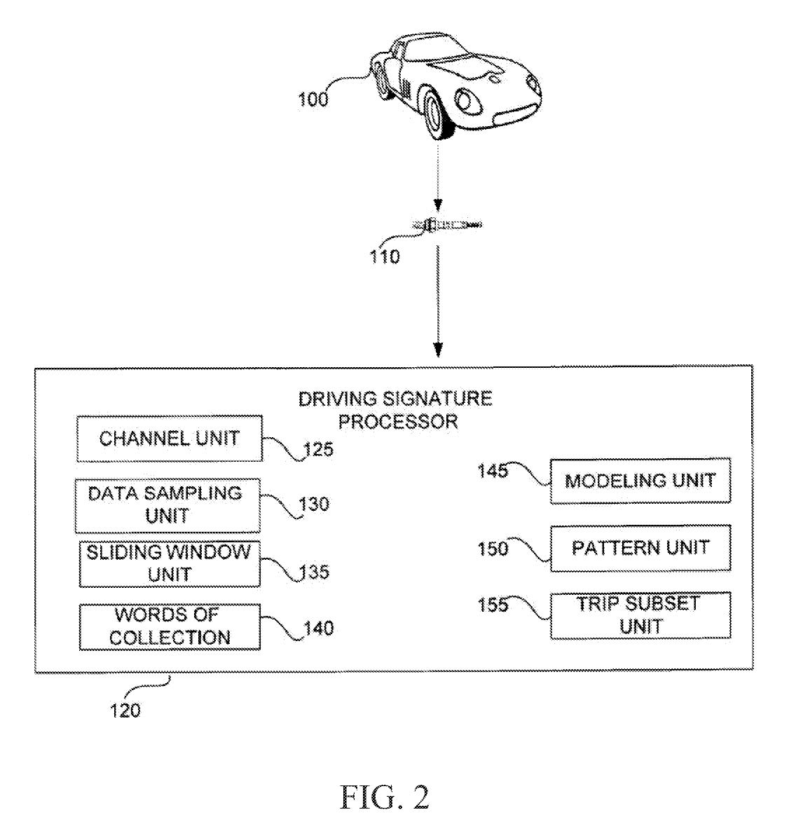

FIG. 2 shows a system for obtaining data samples for determining a driving signature. One or more sensors 110 (e.g., accelerometers, GPS receivers, gyroscopes, OBD readings, etc.) could used to collect the data samples, and could be part of the vehicle or part of a device located in the vehicle. A vehicle 100 is equipped with the one or more sensors 110, which could be used to collect various data samples (e.g., GPS positions, front accelerations, side accelerations, speed readings, multidimensional gyroscope readings, engine speed, use of cellular phone while driving, etc.). In some cases, the sensor 110 applies a smoothing mask or value to the input channel. The data collected or transmitted could be obtained over all the trips of the vehicle or the driver, at any part of those trips, at predetermined trips (e.g., driver's weekdays drive to work), and/or at specified times (e.g., randomly collecting data samples every several hours or every other trip).

The data samples collected could be gathered and transmitted to a central data storage location (e.g., server) where the data samples are processed. In some cases, the data samples could be partially or fully processed at the vehicle by a car system or another device. The sensor 110 could transmit the data samples collected to a driving signature processor 120, which determines the driving signature of the driver who drives the vehicle 100. The driving signature processor 120 includes a channel unit 125, a data sampling unit 130, a sliding window unit 135, a words of collection unit 140, a modeling unit 145, a pattern unit 150, and a trip subset unit 155.

The driving processor 120 is in communication with the vehicle sensor 110. The data sampling unit 130 receives the collected data samples from the sensor 110, and processes and transfers them to the channel unit 125. In some cases, the trip subset unit 155 designates subsets for a trip, which designate when data samples are to be collected (e.g., data samples collected during the third week of every month and only from female drivers). The channel unit 125 determines one or more data channels from which the collected data samples are extracted (e.g., front acceleration channel, location channel, etc.). The sliding window unit 135 performs a sliding window analysis on the channels of the channel unit 125 (e.g., receives data from the channel unit 125), and identifies words of collection (e.g., code words, patterns), which are stored at the words of collection unit 140. The words of collection unit 140 determines the driving signature according to the numbers, and/or frequency, and/or proximity of the different words of collection obtained from the collected data samples. The modeling unit 145 models the driving signatures of a specific driver or multiple drivers (e.g., based on the words of collection stored in the words of collection unit 140). The modeled data could be transferred to a pattern unit 150, which determines patterns in the modeled driving signature.

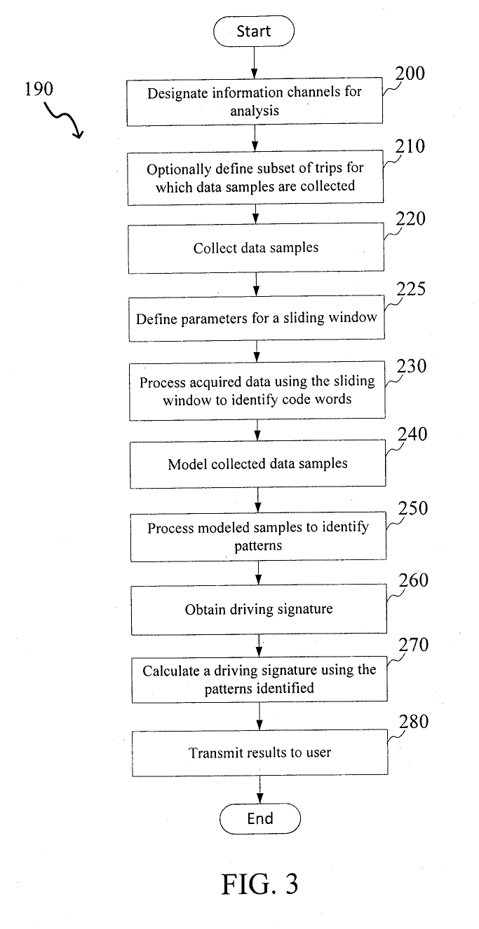

FIG. 3 shows processing steps 190 for determining a driving signature. In step 200, the system designates information channels for analysis and/or collection of data samples via the channel unit 125 of FIG. 2. The channels could be designated for collecting data samples corresponding to GPS positions, front accelerations, side accelerations, speed readings, multidimensional gyroscope readings, engine speed, use of cellular phone while driving, road and vehicle characteristics, traffic and environmental conditions, etc. Each channel could comprise an ordered sequence of values (e.g., scalar numbers indicating the speed of the vehicle at a specific instance). The channels are sampled at discrete intervals in time, where the interval frequency between each sample could vary (e.g., one data sample per second, ten data samples per second, twenty data samples per second, several data samples per second, etc.).

In step 210, the system optionally defines a subset of trips for which data samples are collected. The data samples could be collected according to predetermined criteria. The subset of trips can be defined on all trips or a portion of trips of the vehicle or a group of vehicles, and/or on a set of trips of multiple vehicles. The subset of trips could be selected using parameters that relate to location, time, road characteristics, etc. For example, the subset of trips can be defined on all trips of a vehicle on Tuesdays, all of a driver's trips in a specific month, all weekend trips of a set of drivers, all trips made by a specific driver on highways, etc.

In step 220, the system collects data samples from one or more sensors. The sensor(s) 110 of FIG. 2 installed and/or located in the vehicle 100 of FIG. 2 collect data samples according to the designated channels. The sensor could relate to more than one sensor configured to collect driving performance data (e.g., speed, location, forces applied on the vehicle, etc.). The data samples are collected when the driver drives in the vehicle 100, and are transferred from the sensor 110 to the driving signature processor 120 of FIG. 2.

In step 225, the system defines parameters for a sliding data analysis “window.” By the term “window,” it is meant a pre-defined duration of time (e.g., time period) during which data analysis is performed by the system on data obtained from a data channel. The sliding window is defined by a single word (e.g., pattern), where the word is predefined or defined by data from the channel. The code word (e.g., word of collection) for each sliding window of a specific channel could be selected from a predefined group of words using a predefined set of rules (e.g., to identify predefined patterns in the data) and/or from an undefined group of words that are extracted from the data itself using statistical analysis (e.g., to find patterns in the data). For example, two different sets of values in two sliding windows of the same channel could indicate the same word to represent the two sliding windows. The code words (e.g., words of collection) are defined using several parameters, such as the number of letters in the code words (e.g., the size of the code word) and the number of symbols used per letter in the code word. The sliding window is divided into parts (e.g., uniform/equal parts or non-uniform parts), where each part defines a single letter (e.g., pattern element) in the code words (e.g., the number of parts of the sliding window represents the number of letters in the code word).

The range of the channel is divided into a number of parts (e.g., a uniform or non-uniform division of the channel range), where each part is defined by a symbol (e.g., where some or all of the symbols are different). Each letter in the code word is defined by a number of symbols (e.g., channel elements). The symbol is chosen to be representative of the data of a channel by using average, maximum value, minimum value, median, or other. For example, each code word is divided into 5 letters and the channel is quantized into 7 symbols.

In step 230, the system processes the acquired data using the sliding window to identify code words (e.g., words of collection) in the information channel. The sliding window moves along the data samples of the channel by advancing one step at a time from the beginning of the channel until the end of the channel. A single channel obtained from driving performance data could contain a tremendous number of data samples (e.g., a single channel could include 100,000 data samples), as all the data samples are grouped into sliding windows. The size of the sliding window is predetermined and could vary in length (e.g., from a few milliseconds to several seconds). The size of a step of advancement of the sliding window could vary from one sample to the whole window size (in which case there would be no overlap between sliding windows).

Each sliding window is represented by a word, and the frequency of each word accumulated over the vast number of windows represents the behavioral signature of the driver. In other words, the code words could be accumulated to create the driving signature. For example, a speed channel comprises 240,000 data samples, and the sliding window is 8 samples long with an overlap of 4 data samples between sliding windows, so that the number of sliding windows is about 60,000. After running the sliding window on the channel, a word “x” could represent 15,000 sliding windows while a word “y” represents 12,000 sliding windows and the word “t” represents 9,000 sliding windows.

The type and number of code words could be used to classify the driver (e.g., according to a predefined set of rules). The identity of a word, the type of words, and/or the number of sliding windows represented by each word could be used to determine the behavioral signature of the driver. The identity and number of words representing sliding windows could also be used to determine the classification of the driver. For example, the frequency (e.g., popularity) of a specific word or group of words in the context of a specific driver could classify the driver (e.g., aggressive driver, urban driver, weekend driver, defensive driver, young driver, tailgating driver, frequent roads driver, etc.). Algorithms such as TF-IDF (term frequency inverse document frequency), other “Big Data” algorithms, or other algorithms could be applied to refine the significant words or groups of words (or patterns).

The system and method could also use context (e.g., location) of the driver and/or driving to determine the identity or classification of the driver. The system could assign different meanings for “words” when detected on a particular type of road (e.g., highway, urban road, intersection, etc.), on a particular road condition (e.g., wet roads from raining, dry roads from sunny weather, etc.), at different times on the day, etc. The different meanings of the same word can provide different weights to be given to the same word depending on different times or circumstances (e.g., assign a double weight for a word if determined during a weekend). These different meanings can be added to the channels as an auxiliary process that adds context to the raw data.

In step 240, the system models the collected data samples (e.g., according to the code words). Each letter in the code words is assigned a quantized symbol that could be defined by averaging data of the channel. A driving signature is defined by collecting and accumulating the words for a set of trips and dividing the accumulated number of words by the total number of words that occurred in the set of trips. This provides a normalization that converts the occurrence count into a probability distribution of all the words of collection defined as the signature. The driving signature processor 120 of FIG. 2 could count multiple reoccurring code words.

In step 250, the system processes modeled samples to identify patterns among other drivers (e.g., to compare the patterns and driving behavior with other drivers). Some code words appear more than others during the determination of the driving signature. To compare more efficiently and analyze differences between driving signatures (e.g., analyze differences between other drivers), signature vectors are filtered such that only a part of the values are presented. These values could be selected using inverse trip frequency algorithms. Using such a method, the number of appearances of a word is multiplied by the inverse trip frequency of the word so words representing normal or very common driving behaviors are neglected. In step 260, the system obtains the driving signature, which could be filtered according to frequencies of occurrences of particular words or the proximity of certain words to each other. After the filtering, the driving signature is renormalized as a distribution function.

In step 270, the system calculates a driving signature using the patterns identified, such as to classify and distinguish between different types of drivers according to their driving signatures. The driving signature is used both as an identifier for specific drivers (e.g., identifying which driver is driving a particular vehicle on a specific trip) and as a description of the driver's driving style. Identification could be provided according to distances between the signature data and the “typical” predefined signature of various drivers (e.g., the distance could be a certain statistical benchmark defined to assist in comparing two signatures). The signature comparison results (e.g., whether two signatures are similar enough) could determine whether the two signatures are of the same type of driver (and/or the same driver). A learning period (e.g., one month, 100 miles, etc.) could be required to learn the signature of the driver.

Once signatures are determined they could be classified or clustered according to certain parameters, such as the distance or similarity between them or the context of the drivers (e.g., commuters, weekend drivers, night drivers, professional drivers, senior drivers, new drivers, drivers from the same geographical area, same weather, etc.). The driving signature could be used to classify different driving related attributes of the driver (e.g., driving safety, fuel efficiency, risk awareness, risk exposure, etc.) and/or to map drivers to various objective functions (e.g., claims risk and exposure, accidents risk and exposure, safety level, fuel efficiency, operational efficiency, compliance with regulations, etc.). In this way, based on an already available large database of driving styles, each new trip and/or driver that joins the system can be quickly analyzed and graded based on the distances from the other driving styles that are already available in the system.

In step 280, the system transmits the results to a user (e.g., insurance provider computer systems, insured computer system, etc.). The results could be transmitted by any suitable electronic communication means available (e.g., computer display, email, etc.). The system could also ask the user for input or feedback, such as to teach the system the names of the drivers that drove the same vehicle during the training period of the system (e.g., so that the system could identify the drivers automatically after the training period).

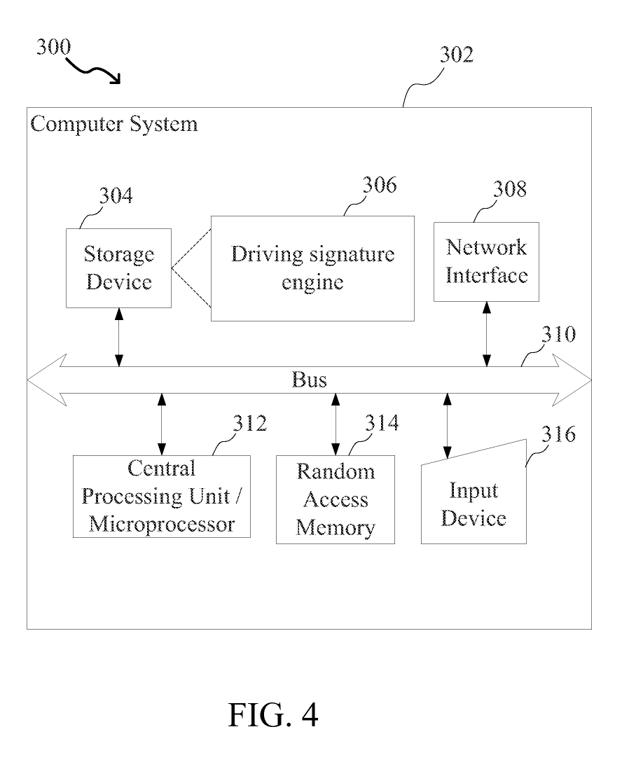

FIG. 4 is a diagram showing hardware and software components of the system 300 capable of performing the processes discussed above. The system 300 comprises a computer system 302 which could include a storage device 304, a network interface 318, a communications bus 310, a central processing unit (CPU) (microprocessor) 312, a random access memory (RAM) 314, and one or more input devices 316, such as a keyboard, mouse, etc. The computer system 302 could also include a display (e.g., liquid crystal display (LCD), cathode ray tube (CRT), etc.). The storage device 304 could comprise any suitable, computer-readable storage medium such as disk, non-volatile memory (e.g., read-only memory (ROM), eraseable programmable ROM (EPROM), electrically-eraseable programmable ROM (EEPROM), flash memory, field-programmable gate array (FPGA), etc.). The computer system 302 could be a networked computer system, a personal computer, a smart phone, etc.

The present invention could be embodied as a driving signature module or engine 306, which could be embodied as computer-readable program code stored on the storage device 304 and executed by the CPU 312 using any suitable, high or low level computing language, such as Java, C, C++, C#, .NET, etc. The network interface 318 could include an Ethernet network interface device, a wireless network interface device, or any other suitable device which permits the server 302 to communicate via the network. The CPU 312 could include any suitable single- or multiple-core microprocessor of any suitable architecture that is capable of implementing and running the driving performance program 306 (e.g., Intel processor). The random access memory 314 could include any suitable, high-speed, random access memory typical of most modern computers, such as dynamic RAM (DRAM), etc.

As described above, a sliding window is applied to a data channel (e.g., front acceleration channel, location channel, etc.). The data channel has a start and an end, and data streams from the channel. The sliding window moves along the data channel to identify one or more iterations of code words in the data of the data channel. The sliding window moves along the data samples of the channel by advancing one step at a time from the beginning of the channel until the end of the channel.

While the disclosure has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this invention, but only by the claims that follow.

What is claimed is:

1. A system for identifying and classifying a driver, comprising:
one or more devices in electronic communication with a network, the one or more devices including one or more sensors for obtaining driving performance data associated with operation of a vehicle by a driver; and
a driving signature engine in electronic communication with the one or more devices, the driving signature engine designating at least one data channel for obtaining driving performance data, processing the driving performance data obtained from the data channel to determine code words, determining a driving signature according to the code words, and identifying or classifying the driver according to the determined driving signature.

2. The system of claim 1, wherein the driving signature engine further applies a sliding window mechanism to the driving performance data.

3. The system of claim 2, wherein the sliding window is defined from a predefined group of patterns using a predefined set of rules.

4. The system of claim 2, wherein the sliding window is defined from a group of patterns that are extracted from driving performance data using statistical analysis.

5. The system of claim 1, wherein the driving performance data is obtained continuously.

6. The system of claim 1, wherein the driving signature engine further defines subsets of trips for which data samples are analyzed.

7. The system of claim 1, wherein the driving signature engine further distinguishes different driver types according to the determined driving signature.

8. The system of claim 1, wherein the driving signature engine further distinguishes different drivers according to the determined driving signature.

9. The system of claim 1, wherein the driving signature engine further determines the driving signature using a context of the driving performance data.

10. A method for identifying and classifying a driver, comprising:
electronically obtaining driving performance data associated with operation of a vehicle using one or more devices having one or more sensors, the one or more devices in electronic communication with a network;
designating, using a driving signature engine in communication with the one or more sensors, at least one data channel for obtaining driving performance data;
processing the driving performance data obtained from the at least one data channel to determine a plurality of code words;
calculating, using the driving signature engine, a driving signature according to the plurality of code words; and
identifying or classifying the driver based on the driving signature.

11. The method of claim 10, further comprising applying, using the driving signature engine, a sliding window mechanism to the driving performance data.

12. The method of claim 11, wherein the sliding window is defined from a predefined group of patterns using a predefined set of rules.

13. The method of claim 11, wherein the sliding window is defined from a group of patterns that are extracted from driving performance data using statistical analysis.

14. The method of claim 10, wherein the driving performance data is obtained continuously.

15. The method of claim 10, further comprising defining subsets of trips, using the driving signature engine, for which data samples are analyzed.

16. The method of claim 10, further comprising distinguishing, using the driving signature engine, different driver types according to the determined driving signature.

17. The method of claim 10, further comprising distinguishing, using the driving signature engine, different drivers according to the determined driving signature.

18. The method of claim 10, further comprising determining, using the driving signature engine, the driving signature by using a context of the driving performance data.

19. A computer-readable medium having computer-readable instructions stored thereon which, when executed by a computer system, cause the computer system to perform the steps of:
electronically obtaining driving performance data associated with operation of a vehicle using one or more devices having one or more sensors, the one or more devices in electronic communication with a network;
designating, using a driving signature engine in communication with the one or more sensors, at least one data channel for obtaining driving performance data;
processing the driving performance data obtained from the at least one data channel to determine a plurality of code words;
calculating, using the driving signature engine, a driving signature according to the plurality of code words; and
identifying or classifying the driver based on the driving signature.

20. The computer-readable medium of claim 19, further comprising applying, using the driving signature engine, a sliding window mechanism to the driving performance data.

21. The computer-readable medium of claim 20, wherein the sliding window is defined from a predefined group of patterns using a predefined set of rules.

22. The computer-readable medium of claim 20, wherein the sliding window is defined from a group of patterns that are extracted from driving performance data using statistical analysis.

23. The computer-readable medium of claim 19, wherein the driving performance data is obtained continuously.

24. The computer-readable medium of claim 19, further comprising defining subsets of trips, using the driving signature engine, for which data samples are analyzed.

25. The computer-readable medium of claim 19, further comprising distinguishing, using the driving signature engine, different driver types according to the determined driving signature.

26. The computer-readable medium of claim 19, further comprising distinguishing, using the driving signature engine, different drivers according to the determined driving signature.

27. The computer-readable medium of claim 19, further comprising determining, using the driving signature engine, the driving signature by using a context of the driving performance data.
